(19) United States
(12) Patent Application Publication
(10) Pub. No.: US 2011/0143767 A1
(43) Pub. Date: Jun. 16, 2011

(54) POSITION A USER IN WIRELESS NETWORK

(75) Inventors: Ningjiang Chen, Shanghai (CN); Xin Chen, Shanghai (CN); Qinfeng Zhang, Shanghai (CN)

(73) Assignee: KONINKLIJKE PHILIPS ELECTRONICS N.V., Eindhoven (NL)

(21) Appl. No.: 12/526,635

(22) PCT Filed: Feb. 16, 2007
(86) PCT No.: PCT/IB2007/050509

§ 371 Date: Aug. 11, 2009

(51) Int. Cl. H04W 24/00

(52) U.S. Cl. 455/456.1

(57) ABSTRACT

The present invention provides a locating apparatus (100) for locating a user in a wireless network, coverage area of the wireless network including at least one functional area, comprising: a transmission source (101) for transmitting a radio signal; a first receiver (111) for receiving the radio signal; a second receiver (112) for receiving the radio signal; a first detector (121) for detecting a first signal variation state of the radio signal received by the first receiver; a second detector (122) for detecting a second signal variation state of the radio signal received by the second receiver; and a determiner (124) for determining whether the user is in one of the at least one functional areas according to the first signal variation state and the second signal variation state.

### FIELD OF THE INVENTION

This invention relates to a wireless network, in particular to a device, system and method for locating a moving person or object in a wireless sensor network.

### BACKGROUND OF THE INVENTION

The position information of a moving person or object in wireless network is very important to the application of the concerned scenes in the wireless network. There is a specific association between the activity of a person and the position information, so we can usually speculate and identify the activity of the person according to the position information of the person.

In the prior art, the moving person or object is usually made to be a mobile node by attaching a sensor or radio frequency label to the body of the person or to the object, thus to achieve the locating of the mobile node in the wireless network.

In a wireless network, the radio signal strength (RSS) is usually an approach for measuring the distance between nodes. For example, in a wireless sensor network usually comprising a plurality of sensor nodes, each of which has the capability of short-range wireless communication to communicate through radio frequency (RF) information with each other. The distance between two sensor nodes can be calculated by means of the Path Loss principle of radio signal.

There are two types of methods for locating a mobile node in the wireless sensor network, i.e., range-based method and range-free method.

The range-based location mechanism needs to measure the distance or angle information between the unknown node and the anchor node, and then calculates the position of the unknown node by trilateration, triangulation or multilateration. The range-based location techniques include radio signal strength indicator (RSSI), TOA (time of arrival), TDOA (time difference on arrival) and AOA (angle of arrival), etc. The ranged-based location techniques use various algorithms to reduce the influence of range measurement error on the location, including multiple measurement, circular location refinement, which bring a plenty of calculations and communication overheads, so the range-based location mechanism is not suitable for the application field of low power-consumption and low cost.

The range-free location mechanism instead needs the distance or angle information, or instead directly measures such information, it locates nodes only based on information such as connectivity of network. The range-free location techniques include DV-Hop, convex programming and MDS-MAP.

However, the above-mentioned method for locating a mobile node in wireless sensor network requires attaching a sensor or RF label on the moving person or object, so such method has the following defects:

(1) It makes the person uncomfortable when a sensor or RF label is attached to their body, meanwhile, the sensor or RF label is prone to be lost or damaged, so it is quite inconvenient.

(2) When no sensor or RF label is attached to the moving person or object, it will be very difficult to locate them in a specific functional area. Furthermore, in some occasions that need locating, it is very inconvenient or even unacceptable to have a sensor or RF label attached to a person. For example, the consumers can hardly accept wearing a specific sensor or RF label when looking at the commodities in a shop.

(3) Meanwhile, in a wireless sensor network, the sensor or RF label attached to the person or object can keep track of every movement of the mobile node, so this is adverse to protecting the privacy of the moving person or object.

Therefore, there is the need for providing a locating apparatus, system and method which does not need to attach a sensor or RF label to the moving person or object.

### OBJECT AND SUMMARY OF THE INVENTION

The present invention provides a device, system and method for locating a moving person or object in a wireless network. The invention needs not to attach a sensor or RF label to the moving person or object.

One of the desires of the present invention is to provide a locating apparatus for locating a user in a wireless network, coverage area of the wireless network including at least one functional area, comprising: a transmitter for transmitting a radio signal; a first receiver for receiving the radio signal; a second receiver for receiving the radio signal; a first detector for detecting a first signal variation state of the radio signal received by the first receiver; a second detector for detecting a second signal variation state of the radio signal received by the second receiver; and a determiner for determining whether the user is in one of the at least one functional areas according to the first signal variation state and the second signal variation state, wherein a angle between the path from the transmitter to the first receiver and the path from the transmitter to the second receiver depends on the width of the interception plane of the user and the position of the at least one functional area in the coverage area of the wireless network.

According to the embodiment of the present invention, the locating apparatus further comprises: a third receiver for receiving the radio signal; a third detector for detecting a third signal variation state of the radio signal received by the third receiver; the determiner for determining that the user is in one of the at least one functional areas according to the first signal variation state, the second signal variation state and the third signal variation state, wherein a angle between the path from the transmitter to the second receiver and the path from the transmitter to the third receiver depends on the width of the interception plane of the user and the position of the at least one functional area in the coverage area of the wireless network.

According to the embodiment of the present invention, the locating apparatus further comprises a controller for generating a control signal when the user is in the functional area.

According to the embodiment of the present invention, the locating apparatus further comprises a counter for counting a first time period of the first signal variation and/or a second time period of the second signal variation. The controller can also be used for generating a control signal when the time period of the user staying at the functional area exceeds a predetermined time period.

According to the embodiment of the present invention, the locating apparatus further comprises a calculator for calculator the speed of the user in the functional area. The controller can configured for generating a control signal when the speed conforms to a pre-set condition.

According to the embodiment of the present invention, the transmitter further comprises a director for directionally transmitting the radio signal to the first receiving end and the second receiving end.

Another desire of the present invention is to provide a light control system. The light control system comprises a locating apparatus according to the present invention, and a lamp connected to the locating apparatus, the lamp operates according to the control signal generated by the controller in the locating apparatus.

Another desire of the present invention is to provide a media playing system. The media playing system comprises a locating apparatus according to the present invention and a media player connected to the locating means, the media player plays a media file according to the control signal generated by the controller in the locating apparatus.

Another desire of the present invention is to provide a locating method for locating a user in a wireless network, coverage area of the wireless network including at least one functional area, the wireless network comprising: a transmitter for transmitting a radio signal, a first receiver for receiving the radio signal, a second receiver for receiving the radio signal, comprising the steps of: detecting a first signal variation state of the radio signal received by the first receiver; detecting a second signal variation state of the radio signal received by the second receiver; determining that the user is in one of the at least one functional areas according to the first signal variation state and second signal variation state, wherein a angle between the path from the transmitter to the first receiver and the path from the transmitter to the second receiver depends on the width of the interception plane of the user and the position of the at least one functional area in the coverage area of the wireless network.

In summary, the locating method provided by the present invention does not need to attach a sensor or RF label to the moving person or object, thus enabling a wider application of the position locating in sensor network. Meanwhile, the locating method of the present invention can save calculation and communication costs, so it is suitable for application field of low power-consumption and low cost.

Other desires and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic drawing of a locating apparatus according to one embodiment of the present invention;

FIG. 2 a schematic drawing of deciding the position of the user in the wireless sensor network according to one embodiment of the present invention;

FIG. 3 a schematic drawing of a light control system according to one embodiment of the present invention;

FIG. 4 a schematic drawing of the arrangement of the functional area in the light control system of the study according to one embodiment of the present invention;

FIG. 5 a schematic drawing of the arrangement of the functional area in the television playing system of the living room according to one embodiment of the present invention;

FIG. 6 is the flow diagram of the method for locating a user in a wireless sensor network according to one embodiment of the present invention.

In all these figures, the same reference indicates the same, similar or corresponding feature or function.

### DETAILED DESCRIPTION OF THE INVENTION

The specific embodiments of the present invention will be described in detail with reference to the figures.

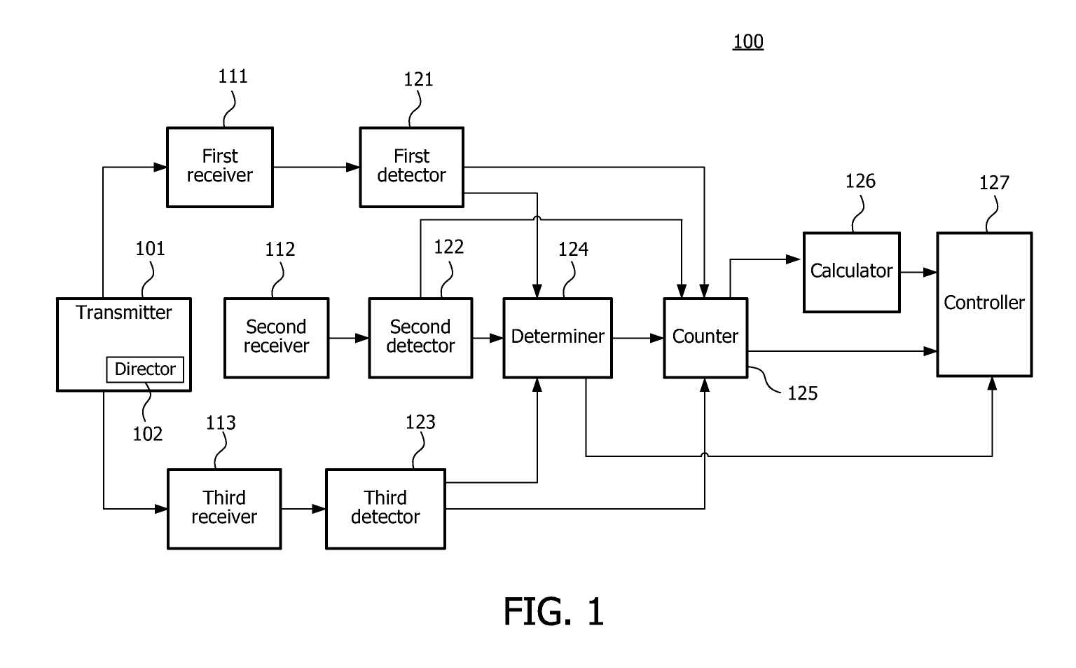

FIG. 1 is a schematic drawing of a locating apparatus 100 according to one embodiment of the present invention.

The locating apparatus 100 is used for locating a user, for example, a person who does not carry the sensor or RF label, in a wireless sensor network. The coverage area of the wireless network includes at least one functional area.

The locating apparatus 100 comprises a transmitter 101, a first receiver 111, a second receiver 112, a first detector 121, a second detector 122 and a determiner 124, wherein the angle between the path from the transmitter 101 to the first receiver 111 and the path from the transmitter 101 to the second receiver 112 depends on the width of the interception plane of the user and the position of the at least one functional area in the coverage area of the wireless network.

The locating apparatus 100 can also comprise a counter 125, a calculator 126 and a controller 127.

In this embodiment, the transmitter 101 and the first and second receiver 111 and 112 adopt CC2420 of Chipcon AS Corporation, which is a radio frequency transceiver of 2.4 GHz conforming to IEEE 802.15.4. Wherein, the antenna of the receiver is outboard monopole sub-antenna. CC2420 is manufactured by 0.18 μm CMOS process based on the SmartRF 03 technique of Chipcon and has very high integration level.

The radio signals transmitted by the transmitter 101 are usually of the following types:

(1) Non-isotropic: the radio signal transmitted by the transmitter 101 has different path losses in different directions.

(2) Continuous variation: the path loss of the radio signal transmitted by the transmitter 101 always changes with the transmission direction of the radio signal transmitted by transmitter 101.

(3) Heterogeneity: the path loss of the radio signal transmitted by the transmitter 101 changes with the transmission power of the transmitter 101, and the transmission power of transmitter 101 depends on factors like the hardware configuration and the battery state.

The radio signal strength received by the first receiver 111 and the second receiver 112 can generally be represented by radio signal strength indicator (RSSI). In non-isotropic radio signal transmission mode, the radio signal strength received by the first receiver 111 and the second receiver 112 can be represented by the following formula:

Received Signal Strength=Transmission Power−Path Loss+Fading

According to the formula, the radio signal strength received by the first receiver 111 and the second receiver 112 (i.e., the received signal strength) equals to the transmission power subtracted by the path loss and added by the fading of the received signal strength caused by change of the ionization condition on the transmission path.

There are many factors that affect the received radio signal strength of the first receiver 111, such as the type of the antenna of the transmission antenna of transmitter 101, the transmission power of transmitter 101, the gain of the transmission antenna of transmitter 101, the gain of the receiving antenna of the first receiver 111 and second receiver 112, the sensitivity of the receiver, and the threshold and signal-to-noise ratio of the receiver.

The first detector 121 is used for detecting a first signal variation state of the radio signal received by the first receiver 111. There are two types of first signal variation states: normal state and blocked state.

When there is no barrier between the transmitter 101 and the first receiver 111, the radio signal received by the first receiver 111 is in the normal state. At this time, the radio signal strength (RSSI) received by the first receiver 111 only varies in a very small range. Factors causing such variation include the changes of the temperature and moisture of the transmission medium in the radio sensor network, electronic interference in the radio sensor network, etc.

When there is a human body blocking between the transmitter 101 and the first receiver 111, the radio signal received by the first receiver 111 is in a blocked state. The human body is mainly composed of water and salt, and this special constitution makes the human body electrically conductive to some extent. When the user is blocking between the transmitter 101 and the first receiver 111, part of the energy of the signal transmitted by the transmitter 101 is absorbed by the human body, so the radio signal strength received by the first receiver 111 fades. When the fading of the radio signal strength received by the first receiver 111 exceeds a certain threshold, the radio signal received by the first receiver 111 will be in the blocked state.

The first detector 121 can be placed in the first receiver or be a part of the remote server.

The second detector 122 detects a second signal variation state of the radio signal received by the second receiver 112. Likewise, the first detector 124 can be placed in the first receiver 114 or be a part of the remote server.

The transmitter 101 may comprise a director 102 for eliminating multipath effect. An important factor that affects the radio signal strength received by the first detector 121 and the second detector 122 is the multipath effect. The multipath effect will be produced when the transmission signal is reflected by the wall, furniture, or other in-door objects. In this circumstance, the transmission signal does not reach the receiver through a single direct path, but through many different paths. The paths through which the signal goes from the transmitter 101 to the receiver (111 and 112) differ in length, so the delay of each signal is different. The finally received signal is in fact the signal generated by multiple superposition, each superposed signal reaches the receiver at a different time, and the strength of each superposed signal is different.

The director 102 can be a directional antenna, such as Helix directional antenna. The director 102 can also be a monopole antenna plus a metal shielding means, such as a tear-off tin with one end open. The director 102 makes the radio signal transmitted by transmitter 101 to be transmitted towards the direction of the first receiver 111 and the second receiver 112, thereby to effectively avoid the multipath effect.

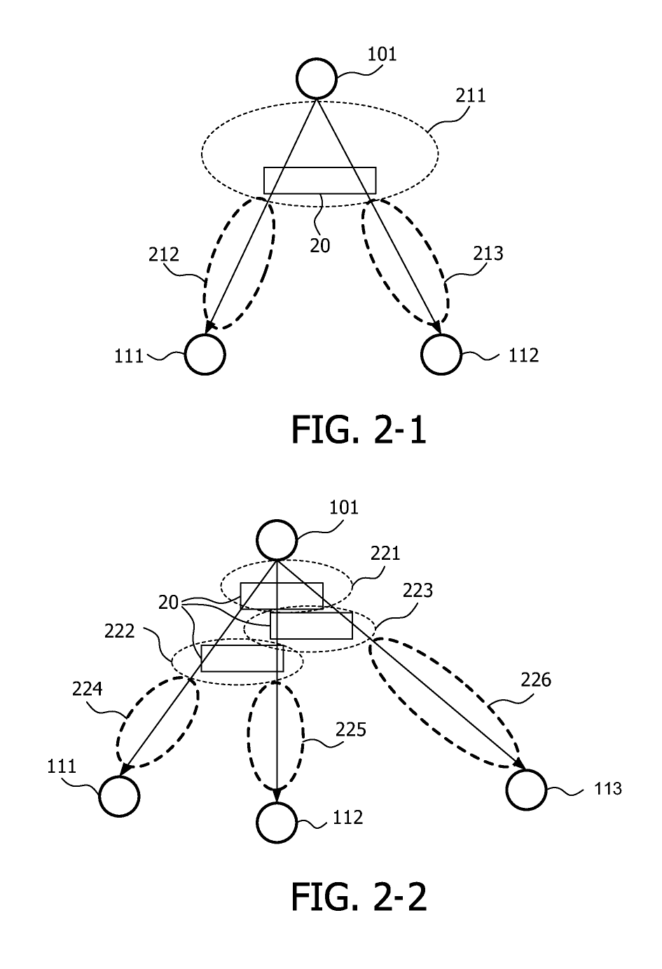

The determiner 124 is used for deciding that the user is in one of the at least one functional areas according to the first signal variation state and the second signal variation state. The computation principle of determiner 124 will be described in detail in conjunction with FIG. 2.

The computation process of determiner 124 can be either centralized computation or distributed computation.

Centralized computation refers to the manner of transmitting the desired information to some central node (e.g., a server) and performing node locating computation therein; while the distributed computation refers to the locating manner of performing the computation by the node itself depending on the information exchange and coordination between nodes.

The advantage of centralized computation lies in that it can make overall plans, that almost no limitation is put to the computation amount and storage amount, and that it can obtain relatively precise position estimation. The disadvantage thereof is that the node that is closer to the central node will exhaust its electric energy untimely owing to the large communication overhead, resulting in the interruption of the information communication between the whole network and the central node, fail implementation of the real-time locating, etc.

In order to divide the radio sensor network into more functional areas, the radio sensor network can further comprise a third receiver 113 for receiving the radio signal transmitted by the transmitter. The locating apparatus 100 can further comprise a third detector 123 for detecting a third signal variation state of the radio signal received by the third receiver 113. At this time, the determiner 120 decides that the user is in one of the at least one functional areas according to the first signal variation state, the second signal variation state and the third signal variation state.

Alternatively, the locating apparatus 100 can further comprise a counter 125 for counting the first time period of the first signal variation and/or the second time period of the second signal variation. In the present embodiment, the first time period of the first signal variation refers to the time period in which the radio signal received by the first receiver 111 is blocked as detected by the first detector 121, it may include the starting time, end time and duration of the radio signal being blocked. Likewise, the second time period of the second signal variation refers to the time in which the radio signal received by the second receiver 112 is blocked as detected by the second detector 122, it may include the starting time, end time and duration of the radio signal being blocked.

The counter 125 can also be used for counting the time period in which the user stays at the position of the wireless network, which is decided by the user at the determiner 124. The counter 125 can be a timing means connected to the first detector 121, the first detector 124 and the determiner 124.

The calculator 126 is used for calculator the speed of the user in the functional area according to the first time period and/or the second time period. The calculator 126 can not only calculate the instantaneous speed of the user in the functional area, but also calculate the average speed of the user who passes through the functional area.

Furthermore, the advancing direction of the user can be predicted according to the sequence of the blocked time period of the radio signal received by the first receiver 111 as detected by the first detector 121 and the blocked time period of the radio signal received by the second receiver 112 as detected by the second detector 122.

The controller 127 is used for generating a control signal when the user is in a specific positional information functional area. The control signal can control the home automation system, building automation system and the light or electronic device in industrial monitoring system.

The controller 127 can also generate a control signal according to the first time period of the first signal variation and/or the second time period of the second signal variation as counted by the counter 125.

The controller 127 can also generate a control signal according to the time period counted by the counter 125 in which the user stays at the position of the wireless network, which is decided by the user at the determiner 124.

The controller 127 can also generate a control signal according to the speed of the user in the functional area obtained by the calculator 126. The controller 127 can also generate a control signal according to the average speed at which the user passes through the tangible grid-shaped area formed by the transmitter 101, the first receiver 111 and the second receiver 112.

The controller 127 can also generate a control signal according to the combination of the above-mentioned cases.

In the present embodiment, the transmitter 101 can also use the single chip radio frequency transceiver chip CC1000 of CHIPCON Corporation and TR1000 of RFM. The single chip radio frequency transceiver chip CC 1000 of CHIPCON Corporation generally works at the frequency of 916 MHz, and the TR1000 of RFM works at the frequency of 868.35 MHz.

FIG. 2 a schematic drawing of deciding the position of the user in the wireless sensor network according to one embodiment of the present invention.

As shown in FIG. 2-1, the transmission power of transmitter 101 is −5 dBm, the signal period of the radio signal transmitted by the transmitter 101 is 250 ms. The distance between the transmitter 101 and the first receiver 111 is 140 cm, and the distance between the transmitter 101 and the second receiver 112 is 160 cm.

Wherein, the angle α between the path from the transmitter 101 to the first receiver 111 and the path from the transmitter 101 to the second receiver 112 depends on the width of the interception plane of the user 20 to be located and the distance from the functional area to the transmitter 101. Suppose that when user 20 is facing the transmitter 101, the width of the interception plane is L1; and when user 20 is facing the transmitter 101 laterally, the width of the interception plane is L2. When L1 is greater than or equal to L2, the angle α depends on the width L1 of the interception plane of the user 20 to be located and the position of the functional area 211 in the sector area formed by the transmitter 101 and the first receiver 111 and second receiver 112. When the width L1 of the interception plane of user 20 is certain, the farther the lower edge of the functional area 211 is from the transmitter 101, the smaller the angle α is.

In a certain period of time period, the radio signal strength received by the first receiver 111 and the second receiver 112 is as shown in table 1.

As shown in table 1, Line 1 represents the received radio signal strength RSSI of the first receiver 111, Line 2 represents the received radio signal strength RSSI of the second receiver, Packet ID represents the time.

Suppose that the variation of the received radio signal strength RSSI of the first receiver 111 exceeds 10 dB, the variation state of the radio signal received by the first receiver 111 as detected by the first detector 121 is blocked state; otherwise, it is the normal state. Likewise, when the variation of the received radio signal strength RS SI of the second receiver 112 exceeds 10 dB, the variation state of the radio signal received by the second receiver 112 as detected by the second detector 122 is blocked state; otherwise, it is the normal state.

When the packet ID is between 800-860, the received radio signal strength RSSI of the first receiver 111 is about −76 to −78 dBm. At this time, the variation state of the radio signal received by the first receiver 111 as detected by the first detector 121 is the normal state. The received signal strength indicator RSSI of the second receiver 112 is about −79 to −80 dBm, then the variation state of the radio signal received by the second receiver 112 as detected by the second detector 122 is also the normal state. According to the computation of the determiner 124, the user is in other areas than the functional areas 211, 212 and 213.

When the packet ID is between 860-900, the received radio signal strength RSSI of the second receiver 112 is faded to −88 to −94 dBm. At this time, the variation state of the radio signal received by the second receiver 112 as detected by the second detector 122 is the blocked state. The received radio signal strength RSSI of the first receiver 112 remains at −79 to −80 d dBm, then the variation state of the radio signal received by the first receiver 111 as detected by the first detector 121 is the normal state. According to the computation of the determiner 124, the user is in the functional area 213.

When the packet ID is between 900-910, the received radio signal strength RSSI of the second receiver 112 is faded to −92 to −94 dBm. At this time, the variation state of the radio signal received by the second receiver 112 as detected by the second detector 122 is also the blocked state. The received signal strength RSSI of the first receiver 111 is faded to −90 to −94 dBm. The variation state of the radio signal received by the first receiver 111 as detected by the first detector 121 is the blocked state. According to the computation of the determiner 124, the user is in the functional area 211 adjacent to the transmitter 101. The width of the intersection of the functional area and the path from the transmitter 101 to the first receiver 111 and the width of the intersection of the functional area and the path from the transmitter 101 to the second receiver 112 equal to the width L1 of the interception plane of the to be located user 20.

When the packet ID is between 910-920, the received radio signal strength RSSI of the first receiver 111 is faded to −90 to −94 dBm, the variation state of the radio signal received by the first receiver 111 as detected by the first detector 121 is the blocked state. The received radio signal strength RSSI of the second receiver 112 is recovered to −79 to −80 dBm, at this time, the variation state of the radio signal received by the second receiver 112 as detected by the second detector 122 is the normal state. According to the computation of the determiner 124, the user is in the functional area 213.

Therefore, according to the present invention, we can decide the different positions of the user at different time period. When Packet ID is between 860-900, the user is in functional area 213. When Packet ID is between 900-910, the user is in functional area 211. When Packet ID is between 910-920, the user is in functional area 212.

As shown in FIG. 2-2, the angle between the path from the transmitter 101 to the first receiver 111 and the path from the transmitter 101 to the second receiver 112 is α1, and the angle between the path from the transmitter 101 to the second receiver 112 and the path from the transmitter 101 to the third receiver 113 is α2. α1 and α2 depend on the width of the interception plane of the user 20 to be located and the distance from the corresponding functional area to the transmitter 101. α1 may be different from α2.

According to the variation states of the radio signals detected by the first detector 121, the second detector 122 and the third detector 123, the position of user 20 can be decided.

When the variation states of the radio signals detected by the first detector 121, the second detector 122 and the third detector 123 are all blocked states, according to the computation of the determiner 124, the user is in functional area 221.

When the variation states of the radio signals detected by the first detector 121 and the second detector 122 are all blocked states, while the variation state of the radio signals detected by the third detector 123 is normal state, according to the computation of the determiner 124, the user is in functional area 222.

When the variation states of the radio signals detected by the second detector 122 and the third detector 123 are all blocked states, while the variation state of the radio signal detected by the first detector 121 is normal state, according to the computation of the determiner 124, the user is in functional area 223.

The distance from the functional area 223 to the transmitter 101 is shorter than the distance from the functional area 222 to the transmitter 101, accordingly, field angle α2 is larger than field angle α1.

When the variation state of the radio signal detected by the first detector 121 is the blocked state, while the variation states of the radio signals detected by the second detector 122 and the third detector 123 are all normal states, according to the computation of the determiner 124, the user is in functional area 224.

When the variation state of the radio signal detected by the second detector 122 is the blocked state, while the variation states of the radio signals detected by the first detector 121 and the third detector 123 are all normal states, according to the computation of the determiner 124, the user is in functional area 225.

When the variation state of the radio signal detected by the third detector 123 is the blocked state, while the variation states of the radio signals detected by the first detector 121 and the second detector 122 are all normal states, according to the computation of the determiner 124, the user is in functional area 226.

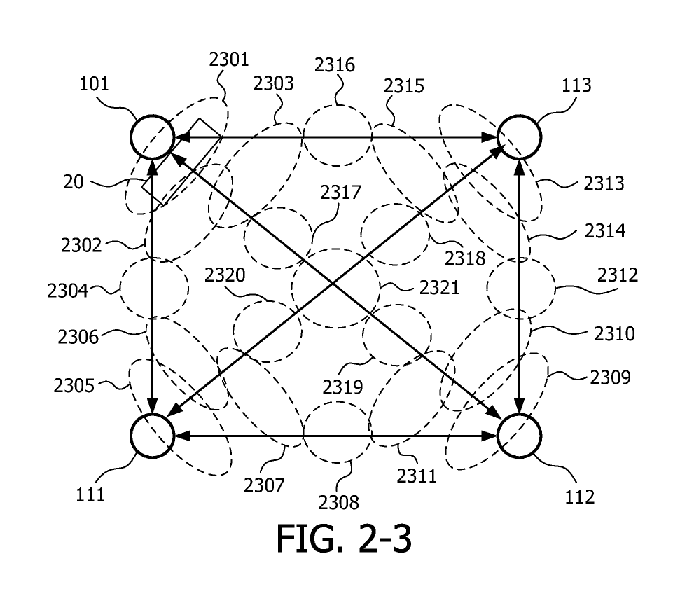

In FIG. 2-3, there are four nodes in the sensor network, and each of sensor node 101, sensor node 111, sensor node 112 and sensor node 113 has the bi-directional communication function of receiving and transmitting.

According to the variation states of the radio signals detected by the detector corresponding to sensor node 101, sensor node 111, sensor node 112 and sensor node 113, the position of user 20 can be decided. The position of user 20 is in one of the following functional areas: 2301, 2302, 2303, 2304, 2305, 2306, 2307, 2308, 2309, 2310, 2311, 2312, 2313, 2314, 2315, 2316, 2317, 2318, 2319, 2320, or 2321. Wherein, functional area 2321 is in the junction of the communication path for sensor node 111 and sensor node 112 and the communication path for sensor node 111 and sensor node 113.

The angle between the path from sensor node 101 to sensor node 111 and the path from sensor node 101 to sensor node 112 depends on the width of the interception plane of the user and the position of the at least one functional area in the coverage area of the wireless network. The same principle applies to other field angles in the rectangle.

FIG. 3 a schematic drawing of a light control system according to one embodiment of the present invention.

The light control system 30 as shown in the figure comprises a locating apparatus 100 according to the present invention, and a lamp 300 connected to the wireless network system. The locating apparatus 100 is used for locating a user in the wireless sensor network, and the locating apparatus 100 comprises a transmitter 101 for transmitting a radio signal; a first receiver 111 and a second receiver 112 for receiving the radio signal transmitted by the transmitter 101, respectively; a first detector 121 for detecting a first signal variation state of the radio signal received by the first receiver; a second detector 122 for detecting a second signal variation state of the radio signal received by the second receiver; a determiner 124 for deciding that the user is in one functional area of the wireless network according to the first signal variation state and the second signal variation state; and a controller 127 for generating a control signal when the user 20 is in a specific functional area; the angle between the path from the transmitter 101 to the first receiver 111 and the path from the transmitter 101 to the second receiver 112 depends on the width of the interception plane of the to user be located and the distance from the functional area to the transmitter 101.

The locating apparatus 101 can further comprise a counter 125 and a calculator 126.

The lamp 300 changes according to the received control signal generated by the controller 127. The lamp 300 can changed the brightness, color and turn-on time thereof according to the control signal. When the system has a large number of lamps, the number of lamps which are in the turn-on state can also be controlled.

The controller 127 can generate a control signal when user 20 is in a specific functional area, it can also generate a control signal according to the time period counted by the counter 125 in which user 20 stays at the position of the wireless network, the speed of the user in the functional area obtained by the calculator 126, or the average speed at which the user passes through the functional area in the area formed by the transmitter 101, the first receiver 111 and the second receiver 112. The controller 127 can also generate a control signal according to a combination of the above-mentioned cases.

The above-mentioned light control system can be used in a fashion shop. When the customer is in a specific functional area, e.g., close to a specific article, the color and brightness of the lamps around the specific article can be changed, thus to make the customer have a different feeling of getting attention timely. Meanwhile, the controller 127 can also send a light signal to the shop assistant of the fashion shop to make the assistant come to introduce the article according to different signal.

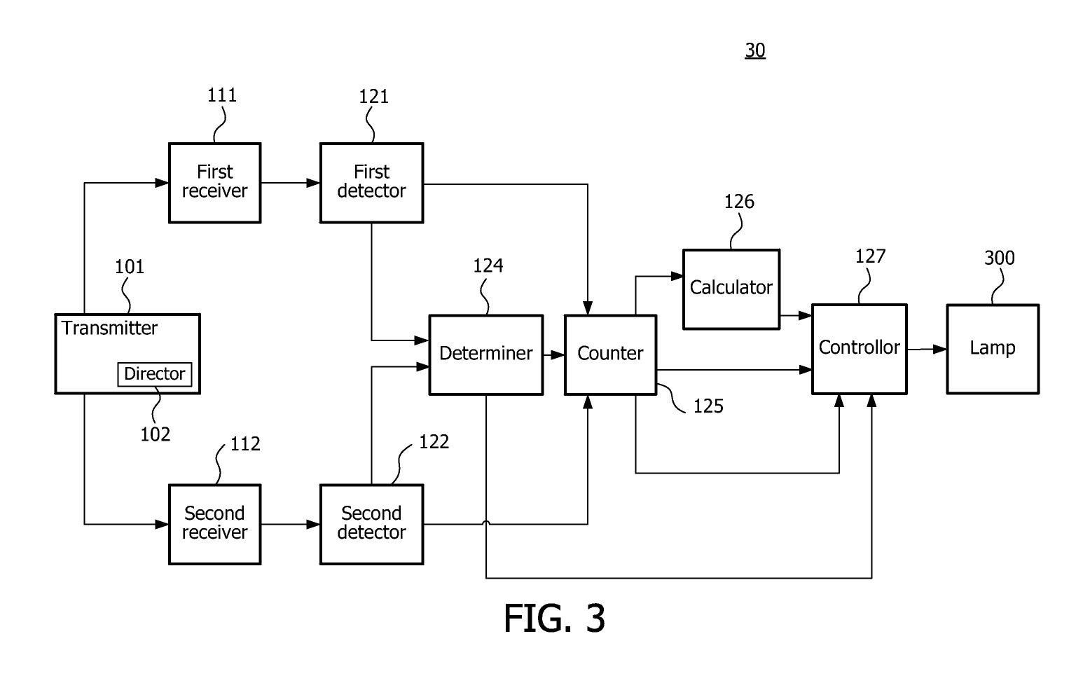

FIG. 4 a schematic drawing of the arrangement of the functional area in the light control system of the study according to one embodiment of the present invention.

As shown in the figure, the transmitter 101 is placed in the position of the desk 420, the receiver 111 and receiver 112 is at the side away from the desk 420. The angle between the path from the transmitter 101 to the first receiver 111 and the path from the transmitter 101 to the second receiver 112 is α. α depends on the width of the interception plane of the user to be located and the distance from the functional area to the transmitter 101.

According to the present invention, when the user is in the functional area 401 that is close to desk 420 and faces the desk, the width of his body blocks both transmission paths of the transmitter 101 with the first receiver 111 and the second receiver 112. The controller 127 (not shown in the figure) sends a control signal, which turns on the desk lamp 410 on the desk 420. When the user leaves the functional area 401 close to the desk 420, the controller 127 sends a control signal, which turns off the desk lamp 410 on the desk 420. When the user is in the functional area 402, 403 or in functional area 401 with body facing the desk laterally, the controller 127 does not generate control signal.

Furthermore, the light control system in the study can also be arranged as that when the user is in the functional 401 that is close to the desk and stays for more than a predetermined time period, the controller 127 (not shown in the figure) sends a control signal, which turns on the desk lamp 410 on the desk 420.

The lamp in this embodiment can be other electronic devices, such as personal computer, or note-book, etc.

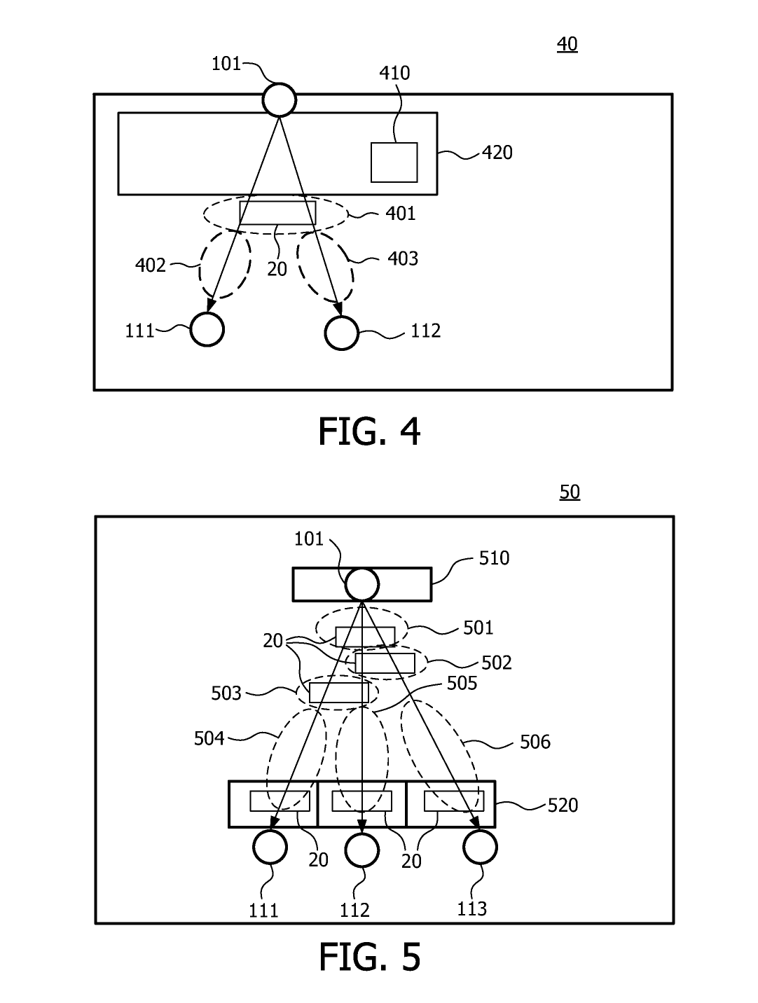

FIG. 5 a schematic drawing of the television control system in the living room according to one embodiment of the present invention.

As shown in the figure, the transmitter 101 is at the position of television 510, the receiver 111, receiver 112 and receiver 113 are distributed on the sofa 520. The angle between the path from the transmitter 101 to the first receiver 111 and the path from the transmitter 101 to the second receiver 112 is α1, and the angle between the path from the transmitter 101 to the second receiver 112 and the path from the transmitter 101 to the third receiver 113 is α2. α1 and α2 depend on the width of the interception plane of the user to be located and the distance from the functional area to the transmitter 101.

According to the present invention, when the user is in functional area 504, 505 or 506, the controller 127 (not shown in the figure) sends a control signal, which turns on the TV 510 that is far away from the sofa. When the user leaves 504, 505 or 506, the controller 127 (not shown in the figure) sends a control signal, which turns off the TV 500 that is far away from the sofa. When the user is in functional area 501, 502, or 503, the controller 127 does not generate control signal for turning on TV 510.

The TV in this embodiment can also be other electronic devices, such as a CD player, a DVD player, etc. According to the present invention, the corresponding functional areas can be arranged according to the positions determined by the user's living habit, thereby to control the electronic device.

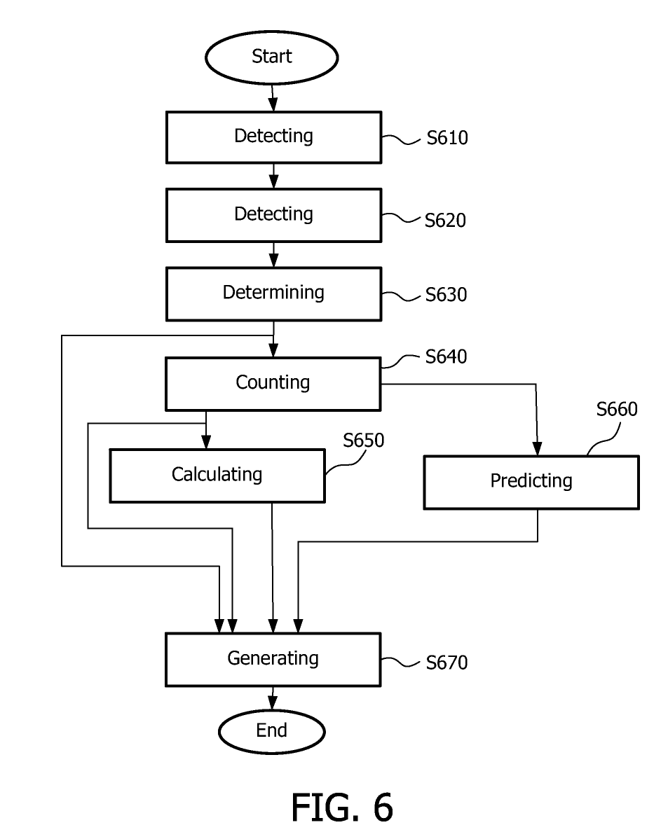

FIG. 6 is the flow diagram of the method of locating a user in a wireless sensor network according to one embodiment of the present invention.

The wireless sensor network comprises at least a transmitter 101 for transmitting a radio signal, a first receiver 111 and a second receiver 112 for receiving the radio signal, respectively, the angle between the path from the transmitter 101 to the first receiver 111 and the path from the transmitter 101 to the second receiver 112 depends on the width of the interception plane of the user and the position of the functional area in the wireless sensor network.

The method of locating a user in the wireless sensor network including the following steps:

First, detecting a first signal variation state of the radio signal received by the first receiver 111 (S610).

There are two types of first signal variation state, i.e., the normal state and the blocked state. When the variation of the received radio signal strength of the first receiver 111 is smaller than a determined threshold, the radio signal received by the first receiver 111 is in the normal state. When the fading of the received radio signal strength of the first receiver 111 exceeds a certain threshold, the radio signal received by the first receiver 111 is in the blocked state. The human body is mainly composed of water and salt, and this special constitution makes the human body electrically conductive to some extent. When the user is blocking between the transmitter 101 and the first receiver 111, part of the energy of the signal transmitted by the transmitter 101 is absorbed by the human body, so the received radio signal strength of the first receiver 111 will fade with exceeding a certain threshold.

The fading of the received radio signal strength of the first receiver 111 may be caused by the fading of the amplitude of the received radio signal, or it may be decided according to the change in both the amplitude and phase of the received radio signal

Second, detecting a second signal variation state of the radio signal received by the second receiver (S620).

Third, deciding that the user is in a functional area of the wireless sensor network according to the first signal variation state and the second signal variation state (S630). The specific deciding method is described in the illustration of FIG. 2.

Next, generating a control signal according to when the user is in a specific functional area (S670).

A specific example is that when the user enters the functional area close to transmitter 101, a control signal is generated to make the light in the functional area in a turn-on state.

The method of position locating in this embodiment, when deciding that the user is in a functional area of the wireless sensor network according to the first signal variation state and the second signal variation state (S630), can also include the step of counting the first time period of the first signal variation and/or the second time period of the second signal variation (S640).

A control signal can be generated according to the first time period of the first signal variation and/or the second time period of the second signal variation (S670). For instance, when the user enters the functional area close to transmitter 101 and stays for more than 30 seconds, a control signal is generated to make the audio player in the functional area 220 to play a piece of music.

Next, the speed of the user in the functional area is calculated according to the first time period and/or the second time period (S650). A control signal can be generated according to the speed of the user in the functional area (S670).

Similarly, after counting the first time period of the first signal variation and/or the second time period of the second signal variation (S640), it may further include the step of predicting the advancing direction of the user according to the first time period and/or the second time period (S660). A control signal can be generated according to the advancing direction of the user (S670).

The control signal can be used for controlling home automation system, building automation system and industrial monitoring system, etc.

Those skilled in the art should understand that the method and device for position locating as provided by the present invention can not only be applied to wireless sensor network, but also be applied to other types of wireless networks, such as the Blue-Tooth micronetwork (Piconet), etc., after being improved in various ways while not departing from the contents of the present invention, and be applied to home and building automation system and industrial monitoring system.

Those skilled in the art should understand that the method and device for locating in wireless network can be improved in various ways while not departing from the contents of the present invention. The method and device for locating in wireless network as disclosed in the present invention can not only locate moving people in the wireless network, but also locate other moving objects, such as a cup or tank full of water, beverage and alcoholic food, etc., as long as those other moving objects are blocking between the transmitter 101 and the first receiver 111 and second receiver 112, the received radio signal strength of the first receiver 111 and second receiver 112 will change obviously

While the invention has been described in conjunction with specific embodiments, it is obvious that many alternatives, modifications and variations will be apparent to those skilled in the art in light of the foregoing description. Accordingly, it is intended to embrace all such alternatives, modifications and variations as fall within the spirit and scope of the appended claims.

1. A locating apparatus (100) for locating a user in a wireless network, coverage area of the wireless network including at least one functional area, comprising:
a transmitter (101) for transmitting a radio signal;
a first receiver (111) for receiving the radio signal;
a second receiver (112) for receiving the radio signal;
a first detector (121) for detecting a first signal variation state of the radio signal received by the first receiver;
a second detector (122) for detecting a second signal variation state of the radio signal received by the second receiver; and
a determiner (124) for determining whether the user is in one of the at least one functional areas according to the first signal variation state and the second signal variation state,
wherein a angle between the path from the transmission source to the first receiver and the path from the transmission source to the second receiver depends on the width of the interception plane of the user and the position of the at least one functional area in the coverage area of the wireless network.

2. The locating apparatus (100) as claimed in claim 1, further comprising:
a third receiver (113) for receiving the radio signal;
a third detector (123) for detecting a third signal variation state of the radio signal received by the third receiver;
the determiner (124) for determining that the user is in one of the at least one functional areas according to the first signal variation state, the second signal variation state and the third signal variation state,
wherein a angle between the path from the transmission source to the second receiver and the path from the transmission source to the third receiver depends on the width of the interception plane of the user and the position of the at least one functional area in the coverage area of the wireless network.

3. The apparatus (100) as claimed in claim 1, wherein the transmission source further comprises a director (102) for directionally transmitting the radio signal to the first receiver and the second receiver.

4. The apparatus (100) as claimed in claim 1, further comprising a controller (127) for generating a control signal when the user is in the functional area.

5. The locating apparatus (100) as claimed in claim 1, further comprising a counter (125) for counting a first time period of the first signal variation and/or a second time period of the second signal variation.

6. The locating apparatus (100) as claimed in claim 5, wherein the controller (127) is configured for generating a control signal when the time period of the user staying at the functional area exceeds a predetermined time period.

7. The locating apparatus (100) as claimed in claim 5, further comprising a calculator (126) for calculating the speed of the user in the functional area.

8. The locating apparatus (100) as claimed in claim 7, wherein the controller (127) is configured for generating a control signal when the speed conforms to a pre-set condition.

9. A light control system (30), comprising a locating apparatus (100) as claimed in claim 4, and a lamp (300) connected to the locating apparatus, the lamp operates according to the control signal.

10. A media playing system (50), comprising a locating apparatus (100) as claimed in claim 4, and a media player (510) connected to the locating apparatus, the media player plays a media file according to the control signal.

11. A locating method for locating a user in a wireless network, coverage area of the wireless network including at least one functional area, the wireless network comprising: a transmission source for transmitting a radio signal, a first receiver for receiving the radio signal, a second receiver for receiving the radio signal, comprising the steps of:
detecting a first signal variation state of the radio signal received by the first receiver;
detecting a second signal variation state of the radio signal received by the second receiver;
determining that the user is in one of the at least one functional areas according to the first signal variation state and second signal variation state,
wherein a angle between the path from the transmission source to the first receiver and the path from the transmission source to the second receiver depends on the width of the interception plane of the user and the position of the at least one functional area in the coverage area of the wireless network.

12. The method as claimed in claim 11, the wireless network further comprising a third receiver for receiving the radio signal transmitted by the transmission source, comprising the steps of:
detecting a third signal variation state of the radio signal received by the third receiver;
the determining step comprising the step of determining whether the user is in one of the at least one functional areas according to the first signal variation state, the second signal variation state and the third signal variation state,
wherein a angle between the path from the transmission source to the second receiver and the path from the transmission source to the third receiver depends on the width of the interception plane of the user and the position of the at least one functional area in the coverage area of the wireless network.

13. The method as claimed in claim 11, further comprising the step of generating a control signal when the user is in the functional area.

14. The method as claimed in claim 11, further comprising the step of counting a first time period of the first signal variation and/or a second time period of the second signal variation.

15. The method as claimed in claim 14, further comprising the step of generating a control signal when the time period of the user staying at the functional area exceeds a predetermined time period.

16. The method as claimed in claim 14, further comprising the step of calculating the speed of the user in the functional area.

17. The method as claimed in claim 16, further comprising the step of generating a control signal when the speed conforms to a pre-set condition.
